(19) United States
(12) Patent Application Publication
(10) Pub. No.: US 2007/0153317 A1
(43) Pub. Date: Jul. 5, 2007

(54) Method and system for providing location based electronic device configuration and confirmation

(75) Inventor: Udo Klein, Maximiliansau (DE)

Correspondence Address: KENYON & KENYON LLP, 1500 K STREET N.W., WASHINGTON, DC, 20005, US

(73) Assignee: SAP AG

(21) Appl. No.: 11/322,991

(22) Filed: Dec. 30, 2005

(51) Int. Cl. G06F 3/12

(52) U.S. Cl. 358/1.15

(57) ABSTRACT

A software method and/or system is provided which may automatically determine the closest printer(s), or other electronic device(s) associated with the same network, to the user's computer location. The user may also use this tool to identify the closest printer(s) or electronic device(s) with specific capabilities. This software method and/or system will notify the user if the user attempts to print to a printer or use another electronic device which is not in close proximity to the user's present determined location. A user who frequently prints to printers which are not in close proximity to his computer may disable warning messages from appearing in the future.

### FIELD OF THE INVENTION

The present invention relates to a system and method for detecting the closest printer to a user's computer location. The present invention more specifically relates to when a printer configuration function is employed, the closest printer to the user's computer terminal is automatically detected and may be engaged by the user's computer terminal.

### BACKGROUND

Today, computer systems may be programmed to include a list of the locations of individual computers and printers operating within the computer network. The location of the computers and printers sometimes is reflected in the naming convention of the network. The computer terminal and printer names are typically based on their locations. For example, computer terminal or printer name may be a concatenation of the city, building, floor and room number of the printer or computer terminal, such as “New York—Main—7-12.”

When a user attempts to locate a printer in the computer network, the user must navigate through different options before being able to locate the printer desired. Often, the user simply wishes to print from a computer terminal to the printer that is located closest to his computer terminal. Under the present system, the user must manually locate the printer to which the user wishes to print.

When a user logs onto a computer terminal which the user does not normally utilize, the default printer associated with the user's login remains the same. Thus, if the user prints from the new location, e.g., on floor 8, the user's printouts will come out from the user's default printer, e.g., on floor 4, even though the computer terminal which he is logged into is not close to the default printer. Accordingly, there is a need in the art for a system and/or method that allows for an automatic or similar access to a closest available printer to a computer terminal.

### BRIEF DESCRIPTION OF THE DRAWINGS

FIG. 1 illustrates a simplified block diagram of a computer system according to an embodiment of the present invention.

FIG. 2A illustrates a diagram of a decision search tree saved in memory according to an embodiment of the present invention.

FIG. 2B illustrates a traversal over particular branches of the decision search tree according to FIG. 2A and the values associated with the traversal.

FIG. 2C illustrates a traversal over particular branches of the decision search tree according to FIG. 2A, and the values associated with the traversal.

FIG. 3 illustrates a dataflow diagram of the operation of an embodiment of the present invention.

FIG. 4 illustrates a dataflow diagram of the operation of another embodiment of the present invention.

FIG. 5 illustrates a graphical representation of the operation of another embodiment of the present invention.

FIG. 6 illustrates a graphical representation of the operation of another embodiment of the present invention

### DETAILED DESCRIPTION

Embodiments of the present invention work cooperatively with existing computer network system(s) to select the closest electronic device of interest, for example, a printer, a plotter, a scanner, a facsimile machine, a photocopier, and the like, to the user's computer location within a network. Embodiments of this device configuration tool, system, and method, may be initiated upon log-in by the user at a terminal, or upon manual selection by the user. When the device tool initiates, the CPU sends a request for a particular electronic device to the network device configuration module, along with a reference to the identity of the user's computer terminal. This reference may be obtained by determining at which terminal the user is logged-in. The network device configuration module then traverses the decision tree that is saved in the network device database in order to determine the closest particular electronic device, for example, a printer, to the user's computer terminal. After the traversal, the device's configuration module sends a reference to the CPU indicating the particular electronic device or set of devices that are close to the user's computer location. The user then may select one of the devices as the user's default device. A reference to the default device for each user may be stored in the user profile memory.

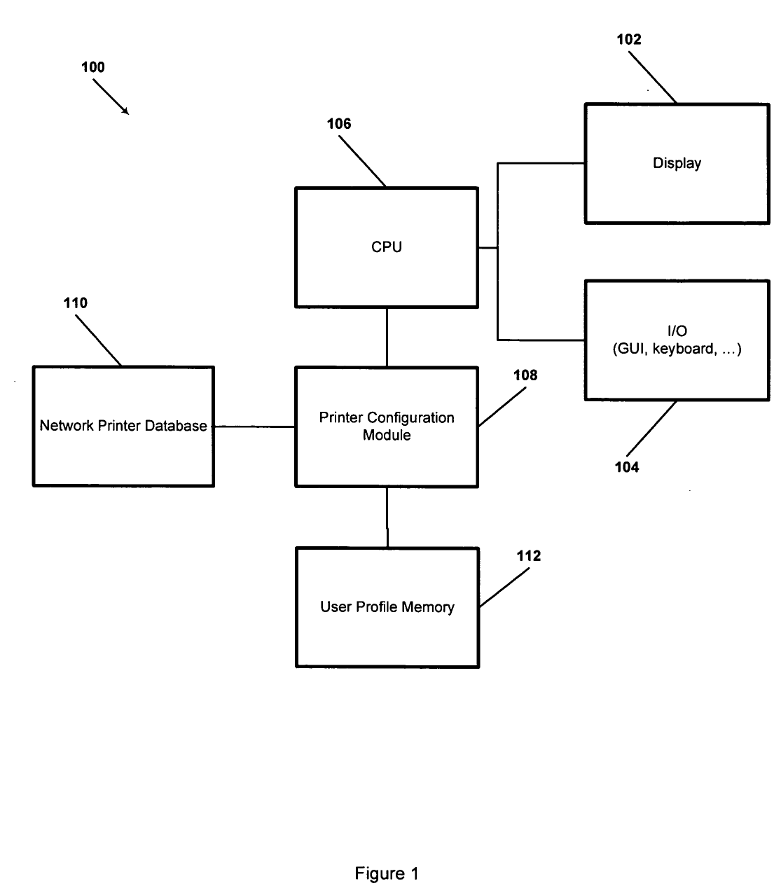

FIG. 1 illustrates a block diagram of an exemplary computer system suitable for use with the present invention. A user may be uniquely identified through a unique identifier associated with his computer. The user indicates a request for, e.g., printer (or other electronic device on the network) configuration or a request to print by way of an input/output device 104, such as a keyboard or a mouse, for example. Notably, the printer is an example electronic device located on the network which can be used in this embodiment and other embodiments of the present invention. Alternatively, the request for print configuration may be automatically activated by the CPU 106, such as during the user's initial log-on. The CPU 106 passes the request onto the printer configuration module 108, which includes a configuration function and a comparison tool. The CPU 106 also sends a reference to the printer configuration module 108 that indicates the computer location that the request is associated with. The printer configuration module 108 then traverses the decision tree in the network printer database 110. When the printer configuration module 108 finishes traversing the decision tree in the network printer database 110, it may access a set of one or more values based on the data generated by the decision tree. This access involves reading the values correlating to the data that the traversal of the decision tree produced. These values correspond to the identities of the printers which are determined to be close to the user's computer location. Thereafter, if the request was for printer configuration, the printer configuration module 108 returns the accessed value to the CPU 106, and displays these values to the user by automatically selecting the printers which the traversal of the decision tree produced. The user may then select one of the printers as his default printer. A reference to each user's default printer may be stored in user profile memory 112. Alternatively, if the request was to print, the printer configuration module 108 compares the accessed values corresponding to the identities of the printers to the identity of the default printer stored in the user profile memory 112 which is associated with the present user. If the identity of the default printer stored in the user profile memory 112 which is associated with the present user is equivalent to one of the accessed printer identities, the printer configuration module 108 returns a positive message to the CPU 106, the print continues. Alternatively, if the identity of the default printer stored in the user profile memory 112 which is associated with the present user is not equivalent to one of the accessed values, the printer configuration module 108 returns an error signal to the CPU 106, and the CPU 106 displays a warning message to the user through the display 102.

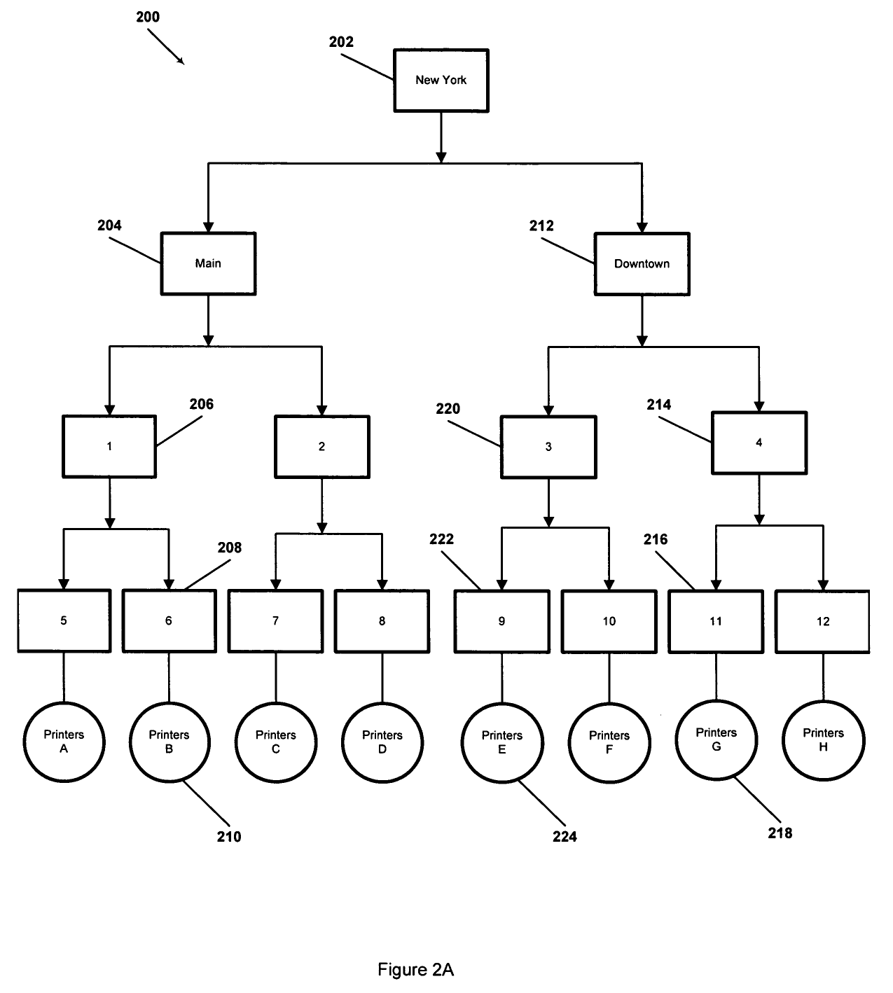

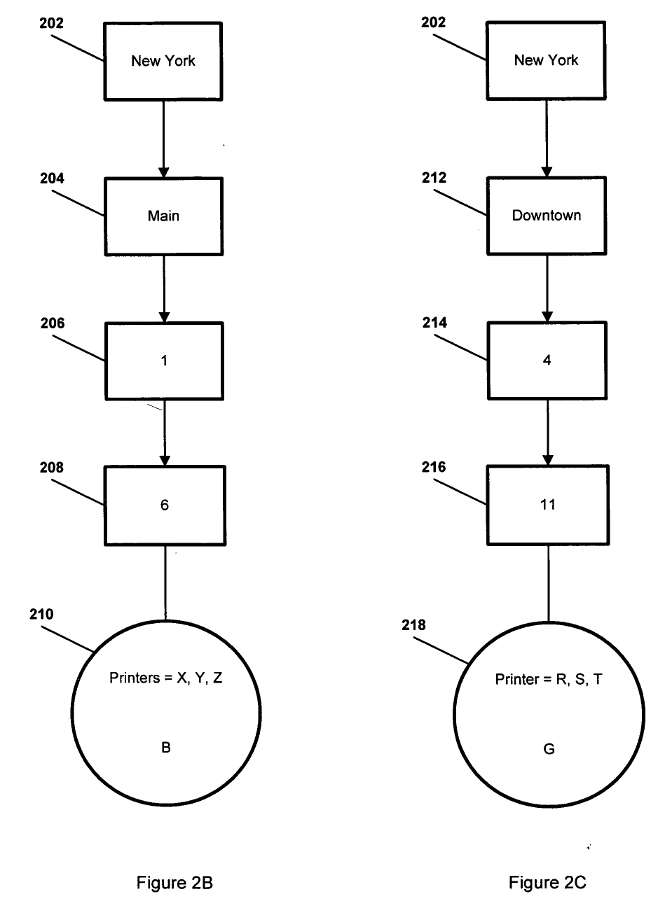

FIG. 2A illustrates an exemplary embodiment of decision tree 200 which is contained in the network printer database 110 and associated with a printer naming system that contains reference to each printer's city, building, floor number and room number. Although FIG. 2A presents an example based on a decision tree data structure, the present invention is compatible with any searchable data structure capable of relating the location of a user's network computer to the location of the network computers. When the printer configuration module 108 receives the reference to the user's computer location, it will be able to traverse the decision tree 200 and obtain a reference to the identities of the printers that are close to the user's computer terminal.

FIGS. 2B and 2C illustrate two different traversals of exemplary decision tree 200. In FIG. 2B, the user's computer terminal is located in New York 202, in the main building 204, on the first floor 208, in room number six 212. When the printer configuration module 108 uses these values to traverse the decision tree 200, it reaches the associated values of printers 216 that are associated with floor one 208, room six 212, of the main building 204 in New York 202. As shown, the printers 216 are X, Y, and Z. The printer configuration module 108 may pass these values to the CPU 106, which may, in turn, return these values to the user by way of display 102.

In FIG. 2C, the user's computer terminal is located in New York 202, in the downtown building 212, on the fourth floor 214, in room number eleven 216. When the printer configuration module 108 uses these values to traverse the decision tree 200, it reaches the associated values of printers 218 that are associated with floor four 214, room eleven 216, of the downtown building 212 in New York 202. As shown, these printers 218 are R, S, and T. The printer configuration module 108 may pass these values to the CPU 106, which may, in turn, return these values to the user by way of display 102.

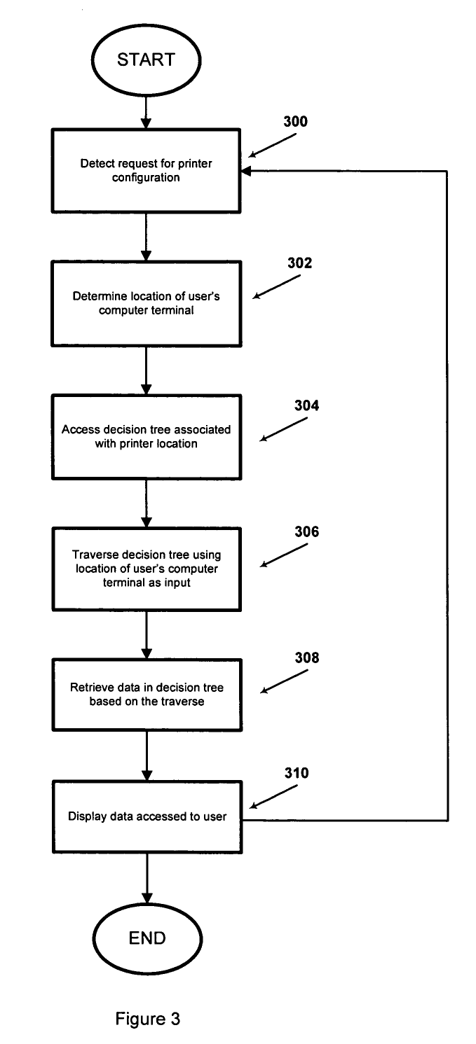

FIG. 3 is a dataflow diagram illustrating an operation of the printer configuration module 108 for one embodiment of the present invention which operates in conjunction with the decision tree referenced in FIGS. 2A-2C. This embodiment of the present invention is operable when the user requests printer configuration or when the printer configuration tool is automatically activated by the CPU 106 during initial user log-on. The method begins when the CPU 106 detects a request for printer configuration, step 300. This may occur during the initial set up of a user's profile or at the specific request of the user. Once the CPU 106 detects the request for printer configuration, it determines the location of the user's computer, step 302. The CPU 106 then forwards the location of the user's computer terminal to the printer configuration module 108. The printer configuration module 108 accesses the decision tree for the network printers from the network printer database 110, step 304, and traverses the accessed decision tree using the location of the user's computer terminal as input, step 306. Once the printer configuration module 108 has successfully traversed the accessed decision tree, it retrieves the related data associated with its traverse of the tree, step 308. This data consists of the identities of all the printers which are in close proximity to the user's computer terminal. For example, a user may be located in room nine 222 on the third floor 220 of the downtown building 212 in New York 202. If that user requests printer configuration, the printer configuration module 108 may take that location and traverse the exemplary decision tree 200 in FIG. 2A. The traversal of the decision tree 200 may access the identities of related printers E 224. The CPU 106 then displays to the user the printers which are closest to his computer terminal, i.e., step 310.

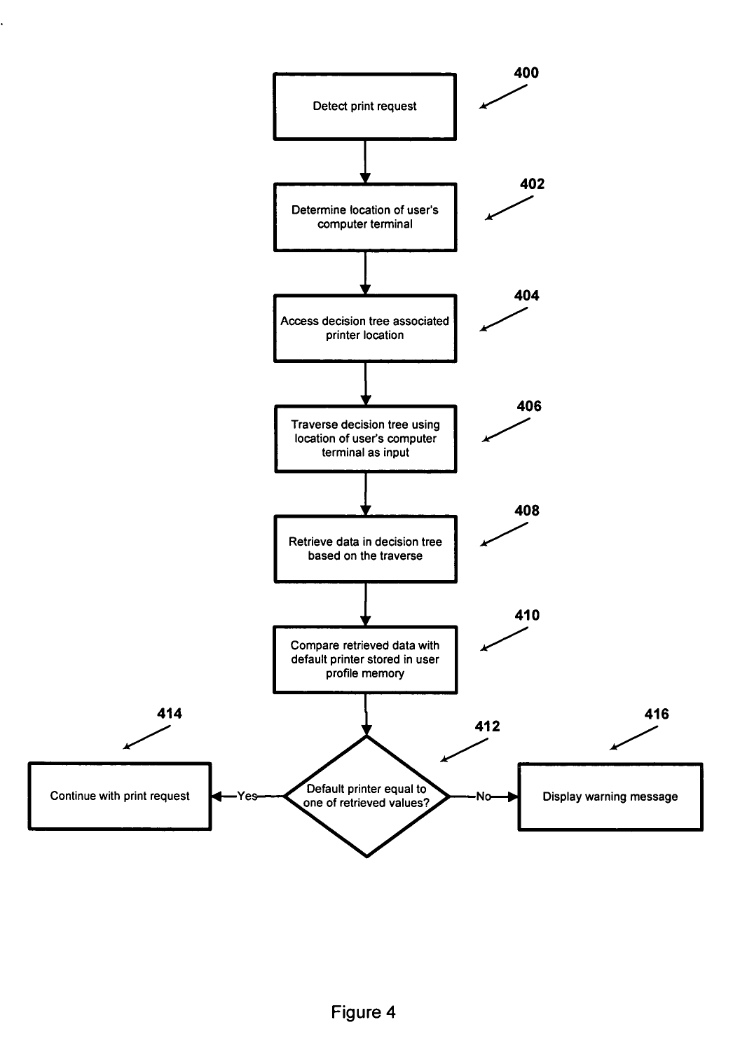

FIG. 4 is a dataflow diagram illustrating an operation of the printer configuration module 108 for an alternative embodiment of the present invention which operates in conjunction with the decision tree referenced in FIGS. 2A, 2B, and 2C. This embodiment of the present invention is operable when the user requests to print a document. The method may be provided to begin when the CPU detects a print request, at step 400. Once the CPU 106 detects the user's request to print, it determines the location of the user's computer terminal, at step 402. The CPU 106 then forwards the location of the user's computer terminal to the printer configuration module 108. The printer configuration module 108 accesses the decision tree for the network printers from the network printer database 110, at step 404, and traverses the accessed decision tree using the location of the user's computer terminal as input, at step 406. Once the printer configuration module 108 has successfully traversed the accessed decision tree, it retrieves the related data associated with its traverse of the tree, at step 408. This data consists of the identities of all the printers which are in close proximity to the user's computer terminal. The printer configuration module 108 then compares the identities of each of the accessed printers with the default printer associated with the present user stored in the user profile memory 112, at step 412. If the identity of the default printer stored in the user profile memory 112 associated with the present user is equal to the identity of one of the printers that was accessed by the printer configuration module 108, the printer configuration module 108 sends a positive message to the CPU 106, and the CPU 106 continues with the print request at step 414. Alternatively, if the identity of the default printer stored in the user profile memory 112 associated with the present user is not equal to the identity of one of the printers that was accessed by the printer configuration module 108, the printer configuration module 108 sends an error message to the CPU 106, and the CPU 106 displays a warning message to the user at step 416.

An embodiment of the present invention is operable to detect the location of the user's computer by way of the port that the computer is connected to. In this manner, the user's location may be detected when he is connected to the network by way of a physical outlet. When the user is connected to the network by a physical outlet, the user's location may be determined regardless of whether the user is using a desktop computer or a laptop computer.

A further embodiment of the present invention is operable to detect the location of the user's computer by way of GPS (Global Positioning System) coordinates. In this embodiment, the user's location may be detected when he is connected to the network through a physical port, or when he is connected to the network through a wireless connection.

In certain circumstances, a user may wish to print to a printer with specific capabilities. For example, a user may wish to print to a printer that is capable of printing in color. Alternatively, a user may wish to print in the most cost-effective manner, and thus print to the printer which would be the least expensive. An embodiment of the present invention is operable to determine the closest printer to the user's location which possesses the desired features specified by the user. Or, a user may wish to connect to a different electronic device on the network. Such a device may include a printer, a plotter, a facsimile machine, a scanner, a photocopier, and the like. The printer is used as an example electronic device on a network for purposes of illustrating embodiments of the present invention.

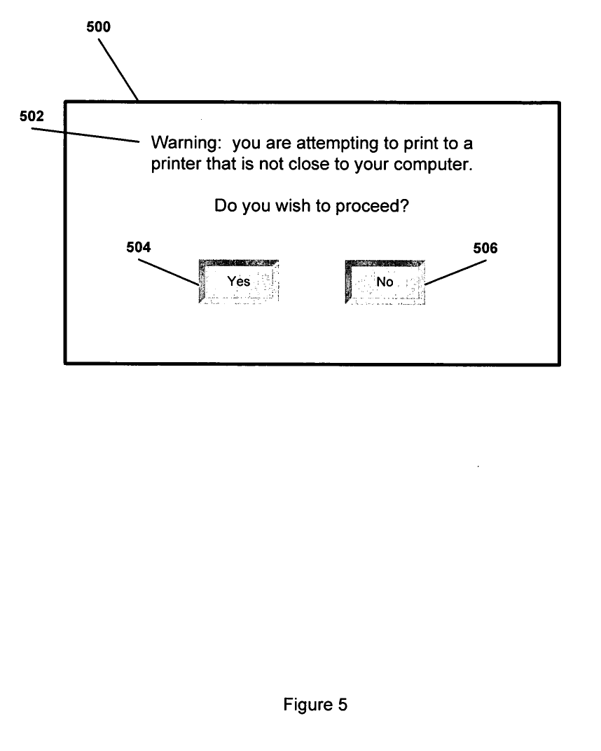

FIG. 5 illustrates a graphical user interface involving a popup warning message 500 or the like appearing on the user's monitor or screen. The warning message 500 may be displayed when the user attempts to print to a printer that the printer configuration module 108 determines is not close to the user's computer location. A statement 502 appears in the warning message and may read, “Warning: you are attempting to print to a printer that is not close to your computer. Do you wish to proceed?” Below this statement 502, there are two generic tool buttons, yes 504 and no 506. If the user wishes to print to the printer that has been selected, he clicks on yes 504 and the print proceeds. If the user does not wish to print to the selected printer, he clicks on no 506 and the CPU 106 sends a request to the printer configuration module 108 to initiate printer configuration.

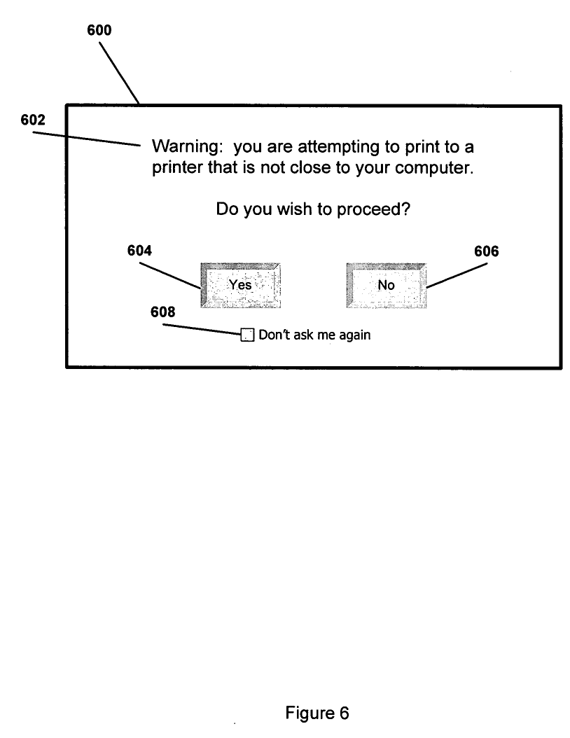

Periodically, a user may frequently print to a printer (or, e.g., request a service of another electronic device located on the network) that is not in close proximity to the location of his computer. Such a user may not wish to have a warning message appear on the display 102 each time he attempts to print to a printer that is not in close proximity to his computer. An embodiment of the present invention is operable to allow a user to disable such warning messages from appearing again. FIG. 6 illustrates an embodiment of the present invention which allows the user to disable the warning message feature. FIG. 6 depicts a graphical user interface of a warning message 600 displayed to the user when the user attempts to print to a printer that the printer configuration module 108 determines is not close to the user's computer location. A statement 602 appears in the warning message and may read, “Warning: you are attempting to print to a printer that is not close to your computer. Do you wish to proceed?” Below this statement 602, there are two generic tool buttons, “yes” 604 and “no” 606. If the user wishes to print to the printer that has been selected, he clicks on “yes” 604 and the print proceeds. If the user does not wish to print to the selected printer, the user clicks on “no” 606 and the CPU 106 sends a request to the printer configuration module 108 to initiate printer configuration. Below the generic “yes” 604 and “no” 606 tool buttons, there may be a checkbox 608 entitled “Don't ask me again.” When the user clicks on the checkbox, a check appears in the box and the feature is enabled. To proceed with the current print request and to prevent future warning messages from appearing on the display 102 when the user attempts to print to a printer that is not close to his computer location, the user checks the “Don't ask me again” box 608 and clicks on the yes 604 button.

What is claimed is:

1. A method of configuring a terminal in use with an electronic device on a network, comprising:
identifying a location of the terminal in use on the network;
determining automatically a location of the electronic device on the network in closest proximity to the location of the terminal; and
configuring a connection between the terminal in use and the electronic device.

2. The method of claim 1, wherein the automatic determining of the location of the electronic device includes:
comparing a directory tree of locations of the electronic device and other electronic devices with the identified location of the terminal in use on the network,
wherein the electronic device in closest proximity to the terminal is the electronic device having a set of location parameters which match closest to a set of location parameters of the terminal on the network.

3. The method of claim 2, wherein the set of location parameters includes at least one of a geographic location, a building location, and a floor location.

4. The method of claim 2, wherein the electronic device is at least one of a printer, a photocopier, a plotter, a scanner, and a facsimile machine.

5. The method of claim 2, further comprising:
requesting by the user for a function of the electronic device which triggers the identifying of the terminal in use, and determining automatically the location of the electronic device.

6. The method of claim 5, wherein the function of the electronic device requested is at least one of a print function, a copy function, a fax function, a plot function, and a scan function.

7. The method of claim 2, further comprising:
comparing first the location of any default electronic device associated with the terminal in use with the location of the other electronic devices determined.

8. The method of claim 7, further comprising:
displaying a message to the user if the default electronic device is not the electronic device on the network in closest proximity to the location of the terminal.

9. The method of claim 2, wherein the identifying of the location of the terminal in use is determined using the port address of the terminal.

10. The method of claim 2, wherein the identifying of the location of the terminal in use is determined by detecting the GPS coordinates of the terminal.

11. A method of configuring a terminal in use with a closest proximity electronic device on a network, comprising:
identifying a profile of a user, the profile containing a location of a default electronic device;
identifying a location of the terminal in use by the user;
in response to a request to use the default electronic device, comparing the location of the default electronic device with the location of the terminal in use;
comparing a location of other same type electronic devices with the location of the terminal in use;
identifying a closest proximity electronic device by determining whether the location of the default electronic device is within a same location range as the location of other same type electronic devices; and
configuring a connection between the terminal in use and the closest proximity electronic device.

12. The method of claim 11, wherein the electronic device is at least one of a printer, a photocopier, a plotter, a scanner, and a facsimile machine.

13. A system for configuration of a closest proximity electronic device with a terminal, comprising:
a location parameter set associated with the terminal;
a respective location parameter set associated with at least one electronic device;
a predetermined rule set for determining closest proximity,
wherein, in response to a request for use of one of the at least one electronic device, a comparison of the respective location parameter sets associated with the terminal and with at least one electronic device is executed using the predetermined rule set for determining closest proximity, and a connection is configured between the terminal and the respective electronic device determined to be in closest proximity.

14. The system of claim 13, wherein the predetermined rule set is a database of at least one location parameter in a specific order of preference.

15. The system of claim 14, wherein the at least one location parameter includes at least one of a country location, a city location, a building location, and a floor location.

16. The system of claim 15, wherein the specific order of preference establishes that the closest proximity electronic device is that whose respective location parameters match with the most at least one location parameter having higher preference order.

17. A computer-readable storage medium storing a set of instructions, the set of instructions capable of causing a processor to implement a method comprising:
identifying a location of the processor in use on the network;
determining automatically a location of a electronic device on the network in closest proximity to the location of the processor; and
configuring a connection between the processor in use and the electronic device.

18. The method of claim 17, wherein the automatic determining of the location of the electronic device includes:
comparing a directory tree of locations of the electronic device and other electronic devices with the identified location of the processor in use on the network,
wherein the electronic device in closest proximity to the processor is the electronic device having a set of location parameters which match closest to a set of location parameters of the processor on the network.

19. The method of claim 18, further comprising:
requesting by the user for a function of the electronic device which triggers the identifying of the processor in use, and determining automatically the location of the electronic device.

20. The method of claim 19, wherein the function of the electronic device requested is at least one of a print function, a fax function, a plot function, a scan function, and a photocopy function.
